(19) United States
(12) Patent Application Publication
(10) Pub. No.: US 2010/0131371 A1
(43) Pub. Date: May 27, 2010

(54) Advertisement providing system, advertisement providing method and program

(75) Inventors: Tetsuo Maruyama, Tokyo (JP); Tetsu Sumita, Tokyo (JP); Tomoki Shirakawa, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignees: Sony Corporation, Tokyo (JP); Plat-Ease Corporation, Tokyo (JP)

(21) Appl. No.: 12/590,243

(22) Filed: Nov. 4, 2009

(30) Foreign Application Priority Data
Nov. 11, 2008 (JP) P2008-288701

(51) Int. Cl. G06Q 30/00

(52) U.S. Cl. 705/14.69

(57) ABSTRACT

There is provided an advertisement providing system including an advertisement article data obtaining unit which obtains advertisement article data of an advertisement item expected to be contained in a publication, an advertisement information preparing unit which prepares advertisement information of the advertisement item from the obtained advertisement article data, an item information obtaining unit which obtains item information of the advertisement item from an electric commerce system which sells the advertisement item, a unit information preparing unit which prepares unit information of the advertisement item by relating the obtained advertisement information and the obtained item information, a unit information providing unit which provides the prepared unit information to the electric commerce system which sells the advertisement item, and a sales log obtaining unit which obtains a sales log of the advertisement item which is sold through the electric commerce system with utilizing the provided unit information.

### CROSS-REFERENCE TO RELATED APPLICATION

The present application claims priority from Japanese Patent Application No. JP 2008-288701 filed in the Japanese Patent Office on Nov. 11, 2008, the entire content of which is incorporated herein by reference.

### BACKGROUND OF THE INVENTION

1. Field of the Invention

The present invention relates to an advertisement providing system, an advertisement providing method and a program.

2. Description of the Related Art

A publisher who issues magazines, books and the like earns advertisement profits by preparing advertisement article data of advertisement items several days before the sale start of such publications and selling the publications which contain the advertisement articles. In addition, the publisher earns non-advertisement profits by selling the advertisement items through one's own electric commerce site (hereinafter, called the publication site) after the sale start of the publications.

### BRIEF SUMMARY OF THE INVENTION

On the other hand, an electric commerce dealer sells the advertisement items through one's own electric commerce site while utilizing advertisement effects of the advertisement article contained in the publication by introducing the advertisement items as the items contained in the publication after the sale start of the publication. In the following, the electric commerce dealer is also called the EC dealer and the electric commerce site of the EC dealer is also called the EC site. It is known that a number of users purchase the advertisement items through the EC sites and not through the publication sites. In that case, the publishers may not ensure non-advertisement profits even though the advertisement items are sold being triggered by one's own-prepared advertisement articles.

Normally, although the advertisement article data is prepared several days before the sale start of the publication, the data is not specifically utilized until the sale start of the publication. Thus, the information value of the advertisement article data is not effectively utilized between the preparation of the advertisement article data and the sale start of the publication. In other words, the opportunity for ensuring non-advertisement profits is lost without utilizing information value of rapidness which the advertisement article data obtains. Here, the rapidness of the advertisement article data denotes timeliness, trendiness and the like included in the advertisement article data. In particular, for items with a short lifecycle, in the case that information value of rapidness which the advertisement article data obtains is not effectively utilized between preparing the advertisement article data and the sale start of the publication, a large opportunity for ensuring non-advertisement profits is to be lost.

In light of the foregoing, it is desirable to provide an advertisement providing system, an advertisement providing method and a program which are capable of effectively utilizing information value of advertisement article data of an advertisement item expected to be contained in a publication.

According to a first embodiment of the present invention, there is provided an advertisement providing system including an advertisement article data obtaining unit which obtains advertisement article data of an advertisement item expected to be contained in a publication, an advertisement information preparing unit which prepares advertisement information of the advertisement item from the obtained advertisement article data, an item information obtaining unit which obtains item information of the advertisement item from an electric commerce system which sells the advertisement item, a unit information preparing unit which prepares unit information of the advertisement item by relating the obtained advertisement information and the obtained item information, a unit information providing unit which provides the prepared unit information to the electric commerce system which sells the advertisement item, and a sales log obtaining unit which obtains a sales log of the advertisement item which is sold through the electric commerce system with utilizing the provided unit information.

With the abovementioned configuration, the unit information of the advertisement item is prepared by relating the advertisement information which is prepared from the advertisement article data of the advertisement item expected to be contained in the publication and the item information which is obtained from the electric commerce system which sells the advertisement item. Then, the unit information of the advertisement item is provided to the electric commerce system which sells the advertisement item. Subsequently, the sales log of the advertisement item which was sold through the electric commerce system with utilizing the unit information is obtained.

Thus, the publisher can ensure a non-advertisement profit by obtaining the sales margin in accordance with the sales log of the advertisement item from the electric commerce system which sold the advertisement item with utilizing the unit information. Further, the publisher can let the electric commerce system sell the advertisement item with utilizing the unit information which includes the advertisement article data of the advertisement item expected to be contained in the publication. In this manner, the publisher can utilize the opportunity for ensuring non-advertisement profits with utilizing the information value of rapidness which the advertisement article data obtains between the preparation of the advertisement article data and the sale start of the publication.

The unit information providing unit may provide the prepared unit information to the electric commerce system which sells the advertisement item before sale start of the publication.

The unit information preparing unit may prepare the unit information of the advertisement item with data included in the advertisement information or the item information which constitute the unit information by being related to unit information of another advertisement item.

The advertisement information preparing unit may prepare the advertisement information of the advertisement item from the advertisement article data of the advertisement item and advertisement article data of an item other than the advertisement item.

The item information obtaining unit may obtain the item information of the advertisement item from a public database of the electric commerce system.

The unit information providing unit may provide the prepared unit information to the electric commerce system by releasing the prepared unit information on a public database of an advertisement system so that the electric commerce system which sells the advertisement item obtains the released unit information.

According to a second embodiment of the present invention, there is provided an advertisement providing method including the steps of obtaining advertisement article data of an advertisement item expected to be contained in a publication, preparing advertisement information of the advertisement item from the obtained advertisement article data, obtaining item information of the advertisement item from an electric commerce system which sells the advertisement item, preparing unit information of the advertisement item by relating the obtained advertisement information and the obtained item information, providing the prepared unit information to the electric commerce system which sells the advertisement item, and obtaining a sales log of the advertisement item which is sold through the electric commerce system with utilizing the provided unit information.

Further, according to a third embodiment of the present invention, there is provided a program for causing a computer to execute the advertisement providing method of the second embodiment.

According to the above-mentioned embodiments of the present invention, there can be provided an advertisement providing system, an advertisement providing method and a program which are capable of effectively utilizing the information value of advertisement article data of advertisement item expected to be contained in a publication.

### BRIEF DESCRIPTION OF THE DRAWINGS

FIG. 1 is a schematic view which illustrates an advertisement providing system according to an embodiment of the present invention;

FIG. 2 is a block diagram which illustrates the configuration of an advertisement providing system according to a first embodiment;

FIG. 3 is a schematic view which illustrates the flow of an advertisement providing method according to the first embodiment;

FIG. 4 is a view which illustrates an example of advertisement article data expected to be contained in a publication;

FIG. 5 is a view which illustrates an example of item information obtained from an EC site;

FIG. 6 is a view which illustrates an example of the configuration of unit information of advertisement items;

FIG. 7 is a view which illustrates an example of a menu screen displayed at the EC site on which the unit information is posted;

FIG. 8 is a view which illustrates an example of an item list including the unit information for a feature article;

FIG. 9 is a view which illustrates another example of the item list including the unit information for another feature article;

FIG. 10 is a view which illustrates an example of an item list including the unit information for a sales feature of the EC site;

FIG. 11 is a view which illustrates a modified example of the configuration of the unit information of the advertisement items;

FIG. 12 is a view which illustrates an example of the unit information displayed at a unit information display area;

FIG. 13 is a view which illustrates an example of display order in a case that data is displayed in predetermined order of the unit information;

FIG. 14 is a block diagram which illustrates the configuration of an advertisement providing system according to a second embodiment; and

FIG. 15 is a schematic view which illustrates the flow of an advertisement providing method according to the second embodiment.

### DETAILED DESCRIPTION

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### 1. Summary of Advertisement Providing System 1

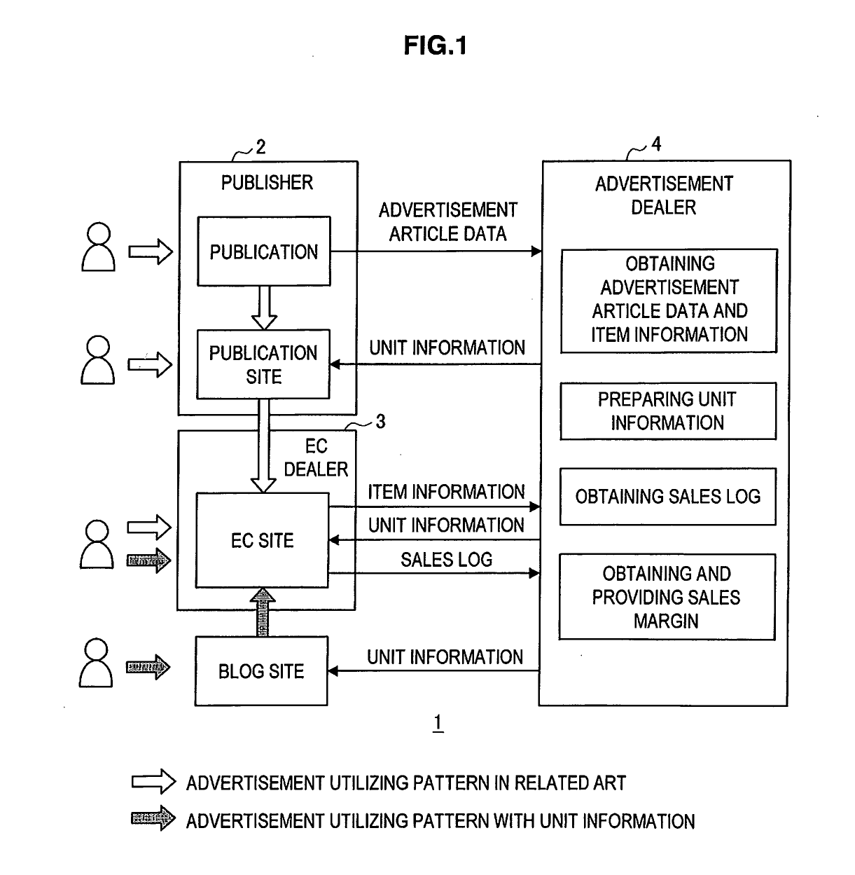

First, the summary of an advertisement providing system 1 according to an embodiment of the present invention will be described with reference to FIG. 1. As illustrated in FIG. 1, the advertisement providing system 1 is operated with a publisher 2, an electric commerce dealer 3 (hereinafter, also called EC dealer 3) and an advertisement dealer 4.

The publisher 2 prepares advertisement article data of advertisement items and sells publications which contain the advertisement articles. The publisher 2 operates an EC system (hereinafter, also called the publication server) for providing one's own electric commerce site (hereinafter, also called the publication site). Then, the publisher 2 sells the advertisement items through the publication site in which one's own-prepared advertisement information from the advertisement article data is contained.

On the other hand, the EC dealer 3 also operates an EC system (hereinafter, also called the EC server) for providing an own electric commerce site (hereinafter, also called the EC site). Then, the EC dealer 3 sells advertisement items through the EC site by posting introduction information which introduces the advertisement items as the items contained in a publication on the EC site along with item information of the advertisement items.

In related art, the publisher 2 has been selling the advertisement items by utilizing one's own-prepared advertisement information from the advertisement article data and the EC dealer 3 has been selling the advertisement items by utilizing item information under one's control. Then, users have purchased the advertisement items through the publication site by referring to the advertisement article contained in the publication or the advertisement information posted on the publication site. Further, users have purchased the advertisement items through the EC site by referring to the advertisement article contained in the publication, the advertisement information posted on the publication site, or the item information and the introduction information posted on the EC site.

On the other hand, the advertisement providing system 1 according to the present embodiment is operated to include the advertisement dealer 4 who operates an advertisement system (hereinafter, also called the advertisement server) for providing unit information which includes the advertisement information and the item information of the advertisement items to the EC site. The advertisement server obtains the advertisement article data expected to be contained in the publication from the publication server and prepares the advertisement information. Then, the advertisement server obtains the item information of the advertisement item from each EC site which sells the advertisement item.

Then, the advertisement server prepares the unit information of the advertisement item by relating the obtained advertisement information and the obtained item information of the advertisement item and provides the unit information to the EC server. The EC server posts the unit information on the EC site. Here, it is preferable that the unit information is posted on the EC site before the sale start of the publication which contains the advertisement information. By the way, it is also possible that the advertisement server provides the unit information to the publication server, a blog server and the like so that the unit information is posted on the publication site, a blog site and the like.

After the advertisement item is sold through the EC site with utilizing the unit information, the advertisement server obtains a sales log of the advertisement item from the EC server. The EC dealer 3 provides a sales margin in accordance with the sales log to the advertisement dealer 4. The advertisement dealer 4 obtains a part of the sales margin as an intermediate margin and provides (i.e., passes) the rest of the sales margin to the publisher 2.

With the advertisement providing system 1 according to the present embodiment, the EC dealer 3 (and the publisher 2) can sell the advertisement items with utilizing the unit information which is prepared by the advertisement dealer 4. Accordingly, users can purchase the advertisement items with referring to the unit information which is posted on the publication site, the EC site, the blog site and the like other than the advertisement article which is contained in the publication and the advertisement information and the item information which are posted on the publication site and the EC site.

The publisher 2 can obtain a part of the sales margin of the advertisement item which is sold with utilizing the unit information in accordance with the sales log of the advertisement item as a non-advertisement profit. Further, the publisher 2 can effectively utilize the information value of rapidness which the advertisement information obtains between the preparation of the advertisement article data and the sale start of the publication by letting the EC dealer 3 sell the advertisement item with utilizing the unit information which includes the advertisement article data expected to be contained in the publication.

### 2. Advertisement Providing System 10 of the First Embodiment

### 2-1. Configuration of Advertisement Providing System 10

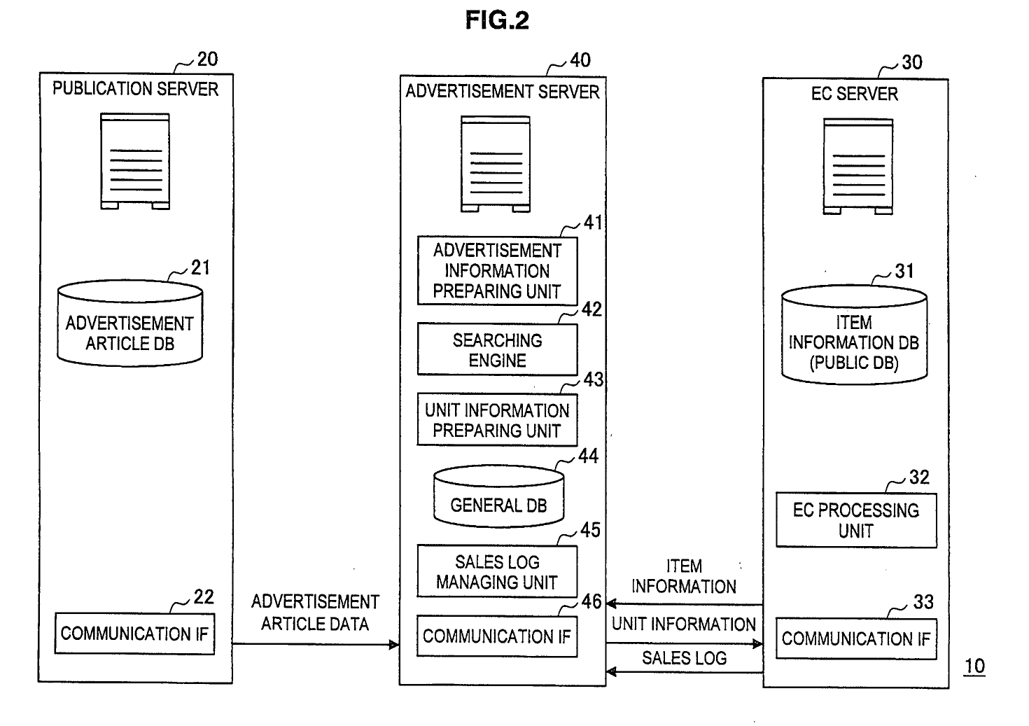

Next, an advertisement providing system 10 according to the first embodiment of the present invention will be described with reference to FIG. 2. As illustrated in FIG. 2, the advertisement providing system 10 according to the present embodiment includes a publication server 20, an EC server 30 and an advertisement server 40. Each of the publication server 20, the EC server 30 and the advertisement server 40 is an information processing system which includes a server device. Here, it is also possible that the advertisement providing system 10 includes a plurality of the publication servers 20 and/or a plurality of the EC servers 30.

The publication server 20 has an advertisement article database (DB) 21 which manages advertisement article data expected to be contained in a publication. Here, the advertisement article data includes the information such as an item code, a name, an image, a manufacturing and selling source, a suggested retail price, additional information (a name, an image and an introduction comment of an advertisement model) of the advertisement item expected to be contained in the publication. Further, the publication server 20 has a communication interface (IF) 22 which transmits the advertisement article data managed by the advertisement article DB 21 to the advertisement server 40.

The EC server 30 has an item information database (DB) 31 which manages item information of items posted on the EC site. Here, the item information includes the information such as an item code, a name, an image, a manufacturing and selling source, and a sale price of the item to be posted on the EC site. The EC server 30 according to the present embodiment releases the item information DB 31 to the advertisement dealer 4 and the like. Therefore, the advertisement dealer 4 can obtain the item information by accessing the item information DB 31 with the advertisement server 40. The EC server 30 has an EC processing unit 32 for performing a process of electric commerce through the EC site.

The EC server 30 has a communication interface (IF) 33 which transmits the item information managed by the item information DB 31 to the advertisement server 40 and receives unit information prepared by the advertisement server 40 from the advertisement server 40. In addition, the communication IF 33 transmits the sales log of the advertisement item which is sold through the EC site to the advertisement server 40.

Further, the EC server 30 also has a control unit which is not illustrated in FIG. 2. The control unit controls the item information DB 31, the EC processing unit 32 and the communication IF 33 and performs a variety of processes for the operation of the EC server 30 by unarchiving a control process program stored at a ROM, for example, to an operational area on a RAM and executing the program.

The advertisement server 40 includes an advertisement information preparing unit 41 which prepares advertisement information from the advertisement article data, a searching engine 42 which searches the item information of the advertisement item, and a unit information preparing unit which prepares the unit information of the advertisement item from the advertisement information and the item information of the advertisement item. In addition, the advertisement server 40 includes a general database (DB) 44 which stores the advertisement information, the item information, the unit information and the like and a sales log managing unit 45 which manages the sales log of the advertisement item. Here, the unit information of the advertisement item, which is specifically described later, is prepared by relating the advertisement information and the item information of the advertisement item. The advertisement server 40 has a communication interface (IF) 46 which performs reception of the advertisement article data from the publication server 20, reception of the item information from the EC server 30, transmission of the unit information of the advertisement item to the EC server 30, and reception of the sales log of the advertisement item from the EC server 30.

Further, the advertisement server 40 also has a control unit which is not illustrated in FIG. 2. The control unit unarchives a control process program stored at a ROM, for example, to an operational area on a RAM and executes the program. Accordingly, the control unit controls the advertisement information preparing unit 41, the searching engine 42, the unit information preparing unit 43, the general DB 44, the sales log managing unit 45 and the communication IF 46 and performs a variety of processes for the operation of the advertisement server 40. Here, the communication IF 46 functions as an advertisement article data obtaining unit, an item information obtaining unit, a unit information providing unit and a sales log obtaining unit in cooperation with the control unit.

### 2-2. Advertisement Providing Method

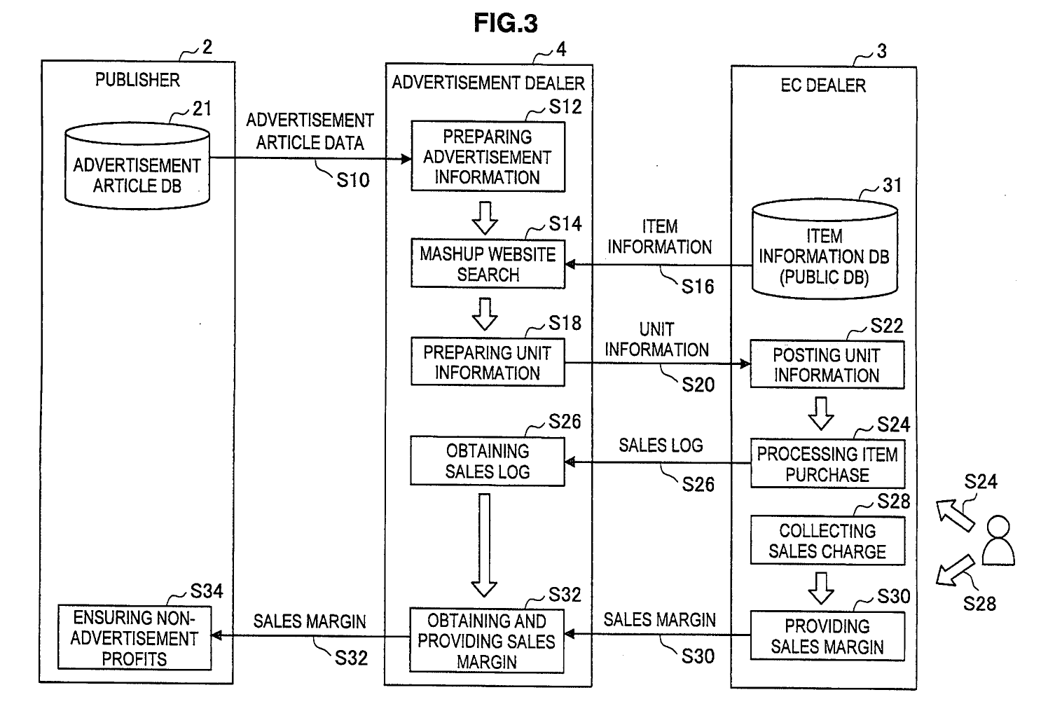

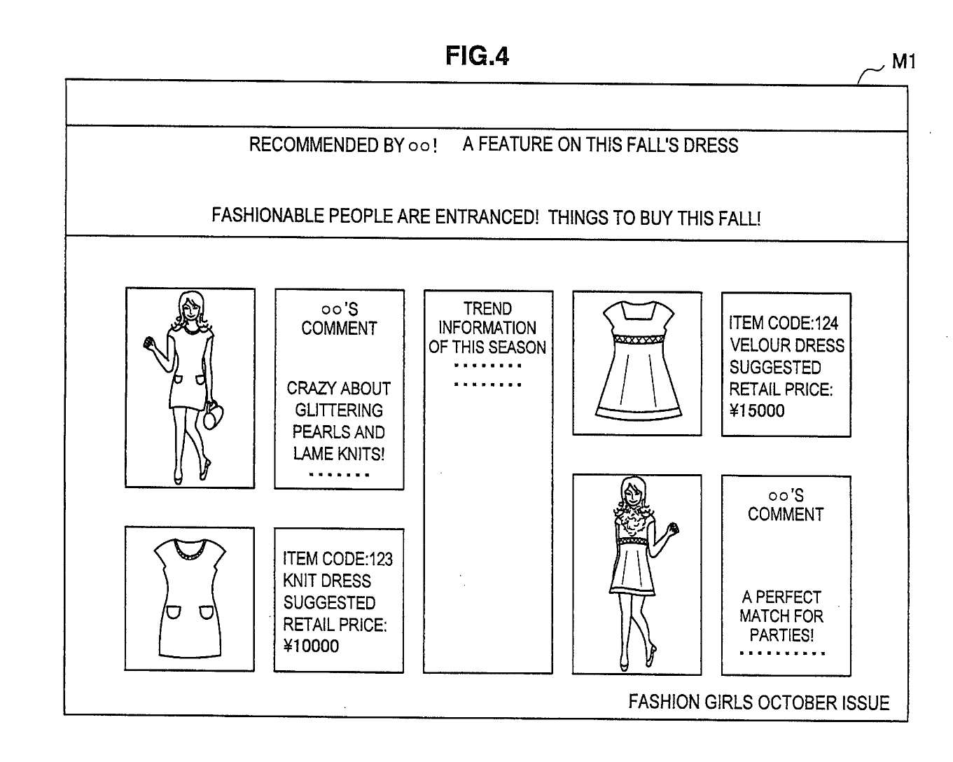

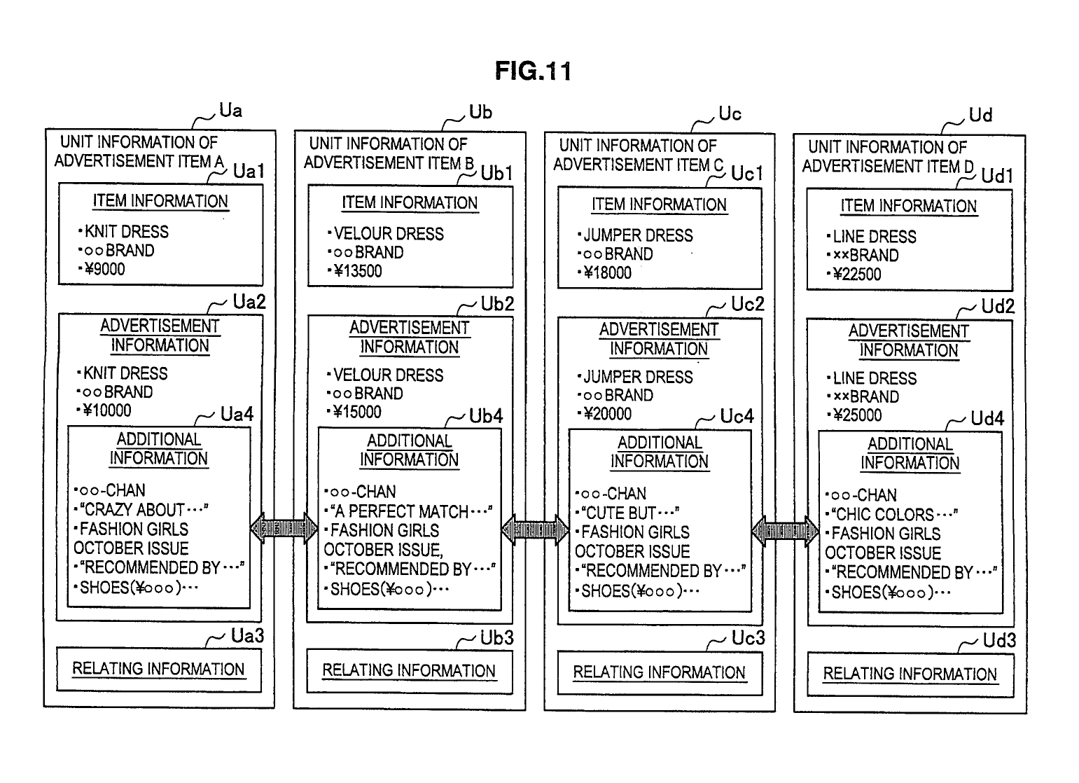

Next, the flow of an advertisement providing method according to the first embodiment of the present invention will be described with reference to FIGS. 3 to 13. FIG. 3 is a schematic view which illustrates the flow of the advertisement providing method. FIGS. 4 to 10 are views for describing the advertisement providing method. FIGS. 11 to 13 are views which illustrate modified examples of posting method of the unit information.

The publisher 2 prepares the advertisement article expected to be contained in the publication as desktop publishing (DTP) data and the like. The publication server 20 manages the advertisement article data with the advertisement article DB 21. The publication server 20 provides the advertisement article data to the advertisement server 40 (step S10).

The advertisement article data includes the item code, the name, the image, the manufacturing and selling source, the suggested retail price, additional information and the like of the advertisement item expected to be contained in the publication. Here, the additional information denotes the information which is added to enhance advertisement effects of the advertisement item for preparing the advertisement article. For example, the additional information is the information such as the name of the advertisement model, the image of the advertisement model, (for example, an image of the model wearing the advertisement item), the item introduction comment by the advertisement model, the name and issue number of publication in which the advertisement article is expected to be contained, and a feature title in which the advertisement article is expected to be contained. Further, the additional information may include related item information of other items which are associated with the advertisement item. For example, the related item information is the information such as item codes, names, suggested retail prices of items to be coordinated with the advertisement item.

The advertisement article data is prepared as DTP data and the like. The advertisement article DB 21 manages the advertisement article data by adding property information (i.e., a data code, a publication code, date and time of preparation etc.).

An example of the advertisement article which is expected to be contained in a fashion magazine is illustrated in FIG. 4. The advertisement article M1 is the article relating to a feature of “Recommended by ••! A Feature on This Fall's Dress” which is expected to be contained in the fashion magazine of “Fashion Girls October Issue”. The advertisement article M1 includes the contents of the feature article and includes the information of an advertisement item A of a knit dress and an advertisement item B of a velour dress. In addition to the item code, the name, the image and the suggested retail price, the information of each advertisement item includes the additional information such as the name and the image of the advertisement model and introduction article of the item.

After obtaining the advertisement article data from the publication server 20, the advertisement server 40 extracts the information of each advertisement item from the advertisement article and prepares the advertisement information of each advertisement item (step S12). Here, the advertisement information of the advertisement item is prepared by extracting respective data such as the item code, the name, the image, the manufacturing and selling source, and the suggested retail price of the advertisement item, and the additional information from the advertisement article data and adding a tag to the respective data for specifying the data type. Further, for example, the advertisement information is prepared using the item code and the name etc. as the search criteria. The advertisement server 40 stores the prepared advertisement information of each advertisement item at the general DB 44. Here, in the case that the publication server 20 manages the advertisement information which is prepared by the publisher 2 from the advertisement article data, the advertisement server 40 may obtain the advertisement information instead of the advertisement article data.

After preparing the advertisement information of each advertisement item, the advertisement server 40 specifies the EC site which sells each advertisement item (step S14). Here, as described above, the item information DB 31 of each EC server 30 is released. Then, the advertisement server 40 specifies the EC site which sells each advertisement item by performing a mashup search against the item information DB 31 of each EC server 30 using the item code and the name etc. in the advertisement information of each advertisement item as the search criteria. Here, the mashup search is performed against the item information DB 31 which is managed by each EC server 30 and is released to the advertisement dealer 4 and the like. Accordingly, the item information which is managed by a different EC server 30 can be searched with one searching process.

The item information is the information which includes the item code, the name, the category, the image, the manufacturing and selling source, and the sale price of the item posted on the EC site. The item information DB 31 of each EC server 30 manages the item information by adding the property information (i.e., a data code, an EC site code, date and time of preparation etc.) for the respective item information.

After specifying the EC site which sells each advertisement item, the advertisement server 40 obtains the item information of each advertisement item from the item information DB 31 of the EC server 30 providing the EC site which sells each advertisement item in step S16. A tag for specifying respective data such as the item code, the name, the category, the image, the manufacturing and selling source, and the sale price may be previously added to the item information of each advertisement item or may be added by the advertisement server 40. The advertisement server 40 stores the obtained item information of each advertisement item at the general DB 44 for each EC site of the item information source.

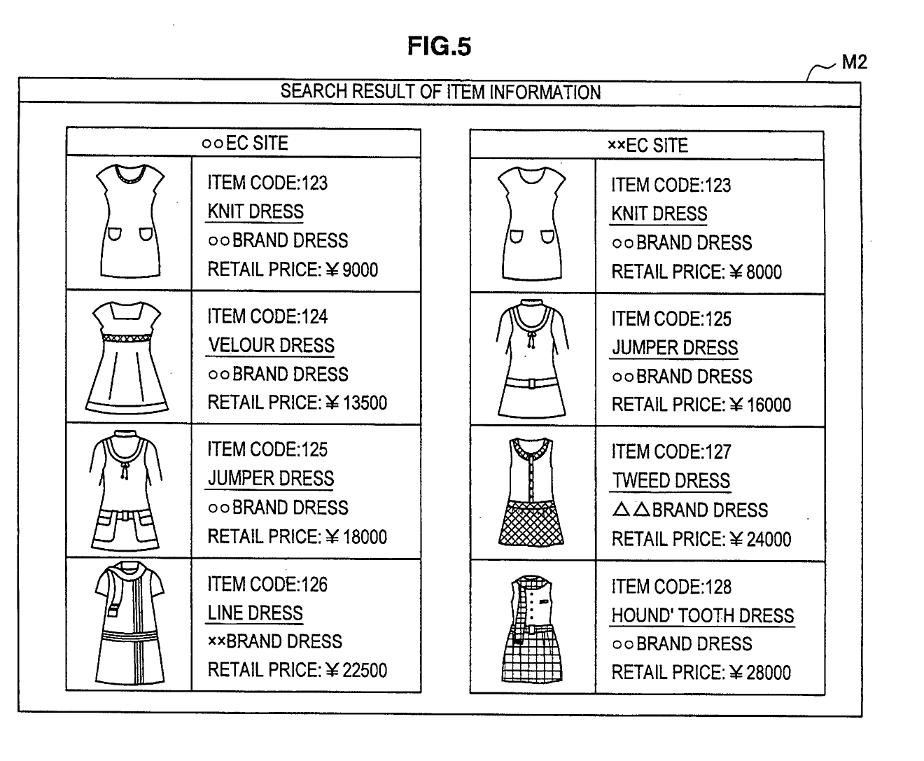

An example of the item information which is obtained from each EC site is illustrated in FIG. 5. FIG. 5 indicates a result M2 of the mashup search for the item information of the advertisement item expected to be contained in the advertisement article M1 of FIG. 4. According to the search result M2, “•• EC site” sells the advertisement item A of the knit dress, the advertisement item B of the velour dress, an advertisement item C of a jumper dress, and an advertisement item D of a line dress. Then, “xx EC site” sells the advertisement item A of the knit dress, the advertisement item C of the jumper dress, the advertisement item D of the line dress, and an advertisement item E of a hound's tooth dress. Thus, selling items are varied corresponding to the EC site and the sale prices of the same item may be set different.

After obtaining the item information of the advertisement item, the advertisement server 40 prepares the unit information for each EC site by relating the advertisement information of each advertisement item prepared from the advertisement article data and the item information of each advertisement item obtained from each EC server 30 (step S18).

### (Configuration of Unit Information)

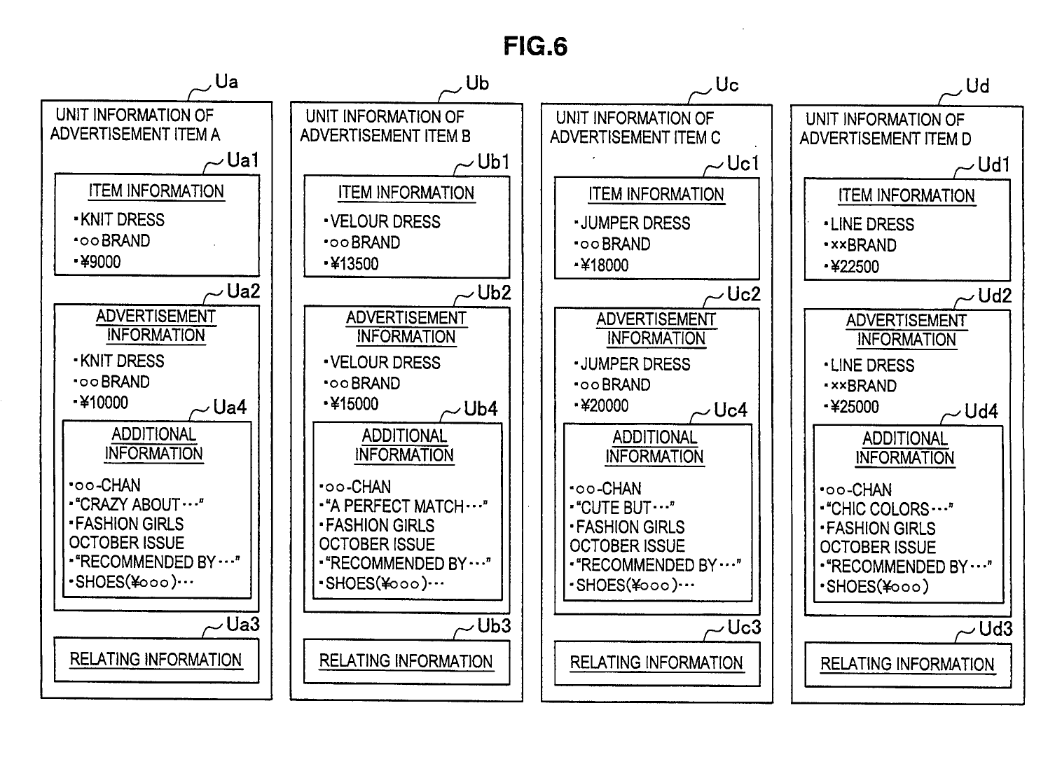

The unit information is prepared by relating the item information and the advertisement information of each advertisement item. An example of the configuration of the unit information of the advertisement item is illustrated in FIG. 6. Here, only a part of the data included in the unit information is illustrated in FIG. 6. In the example of FIG. 6, four of the unit information Ua, Ub, Uc and Ud of the advertisement item A of the knit dress, the advertisement item B of the velour dress, the advertisement item C of the jumper dress, and the advertisement item D of the line dress are illustrated.

In the example of FIG. 6, for example, the unit information Ua of the advertisement item A includes the item information Ua1 of the advertisement item A, the advertisement information Ua2 of the advertisement item A and relating information Ua3. Here, the unit information Ua will be described in the following. Then, other unit information is configured to be similar to the unit information Ua.

The item information Ua1 includes the item code, the name, the image, the manufacturing and selling source, and the sale price of the advertisement item A. The advertisement information Ua2 includes the item code, the name, the image, the manufacturing and selling source and the suggested retail price of the advertisement item A. Further, the additional information Ua4 in the advertisement information Ua2 includes the name, the category and the image of the advertisement model, the introduction article by the model, the name and the issue number of the publication in which the advertisement article is expected to be contained, the feature title in which the advertisement article is expected to be contained, and the information of the related items. Here, the information of the related items may be the information which is included in the advertisement article or the information which is prepared and added by the advertisement server 40 in accordance with relativity among the advertisement items when the unit information Ua is prepared. The relating information Ua3 includes the information for relating the item information Ua1 and the advertisement information Ua2 as the unit information.

The example of the configuration of the unit information which is posted on “•• EC site” is illustrated in FIG. 6. The unit information which is posted on another EC site is prepared in accordance with the advertisement item and the sale price which are carried thereat.

After preparing the unit information, the advertisement server 40 provides the unit information which is prepared for each EC site to each corresponding EC server 30 (step S20). Here, it is preferable that the advertisement server 40 provides the unit information to the EC server 30 before the sale start of the publication in which the advertisement article data of the advertisement item is to be contained. Accordingly, the EC server 30 can ensure the information value of rapidness which the advertisement article data obtains. The EC server 30 posts the unit information of the advertisement item on the EC site and promotes purchasing of the item with utilizing the unit information (step S22).

### (Posting Method of Unit Information)

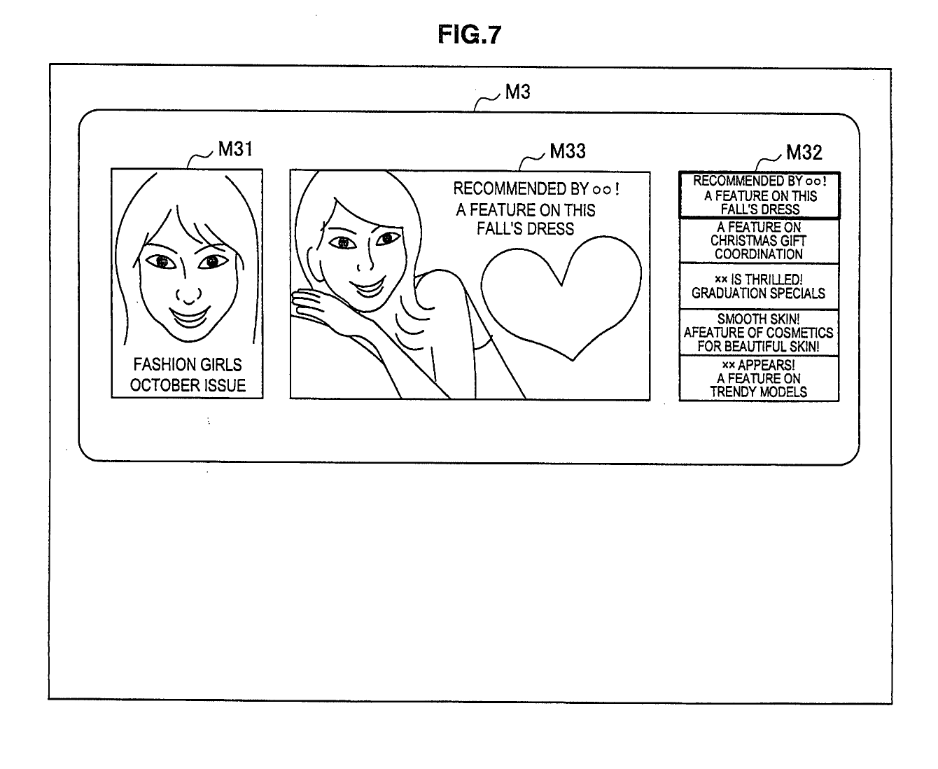

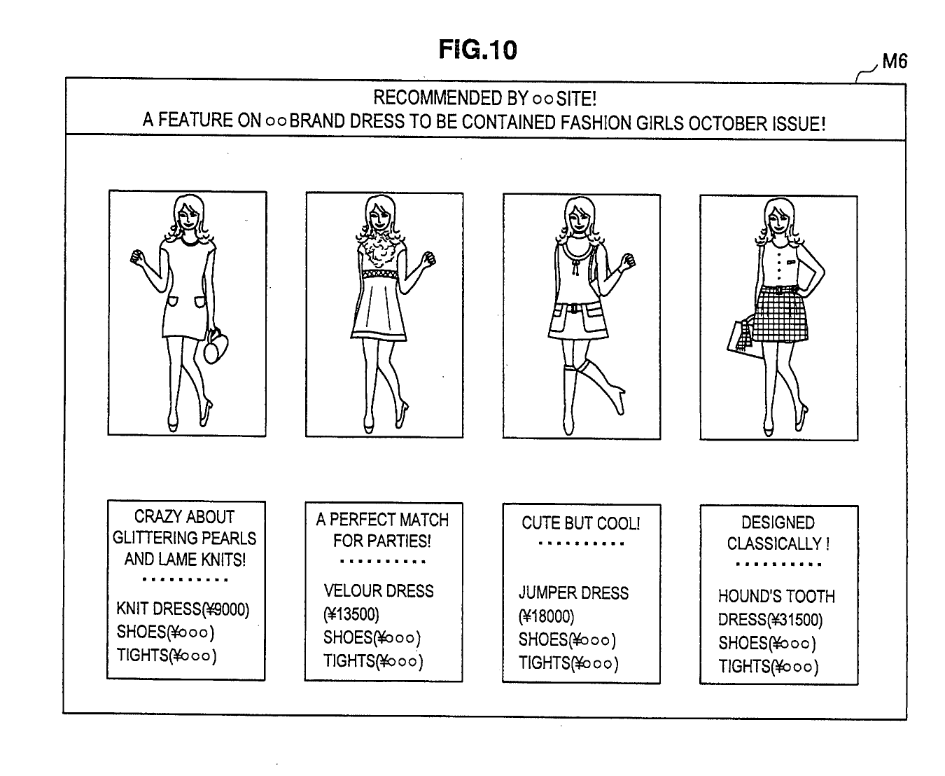

In the following, a posting method of the unit information of the advertisement item will be described with reference to FIGS. 7 to 10. In FIGS. 7 to 9, the cases of posting the unit information which is edited by the advertisement dealer 4 in accordance with the feature article expected to be contained in the publication are illustrated. The case of posting the unit information which is reedited by the EC dealer 3 in accordance with a sale feature is illustrated in FIG. 10. In the following, the case of posting the unit information edited for “•• EC site” will be described as an example.

FIG. 7 is an example of a menu screen for displaying the unit information of the advertisement item. The menu screen M3 displays a cover image M31 of the publication, a list M32 of feature articles expected to be contained in the magazine and a title image M33 of the feature article which is selected on the list M32. The menu screen M3 displays the cover image M31 of the fashion magazine of “Fashion Girls October Issue”, and the list M32 of the feature articles such as “Recommended by ••! A Feature on This Fall's Dress” and “A Feature on Christmas Gift Coordination”. In addition, the menu screen M3 displays the title image M33 of the feature article which is selected on the list M32.

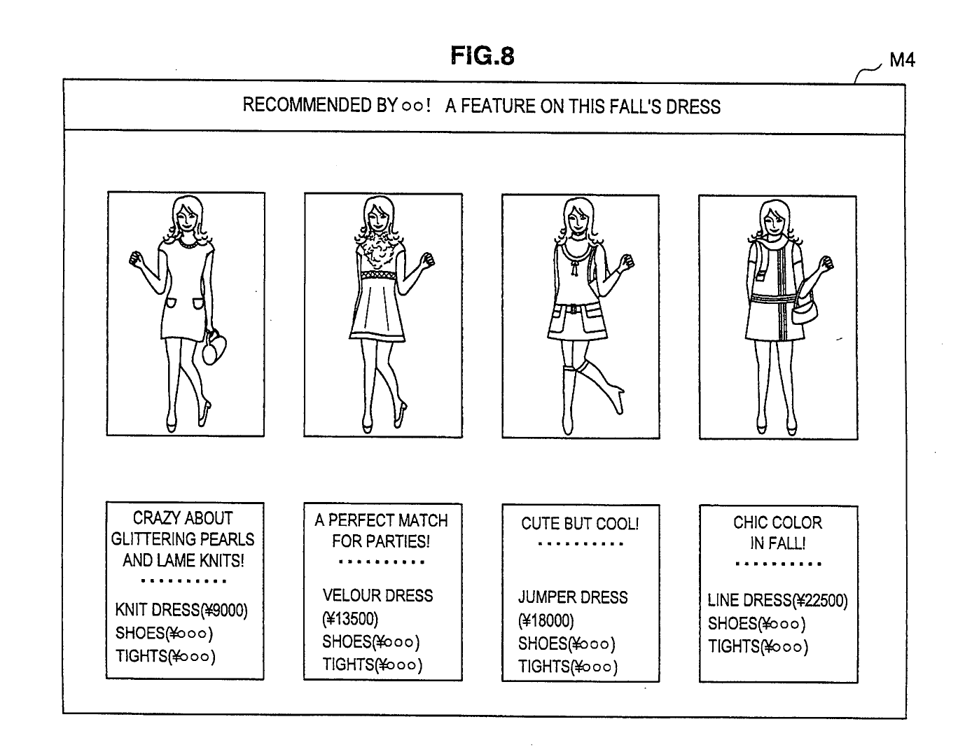

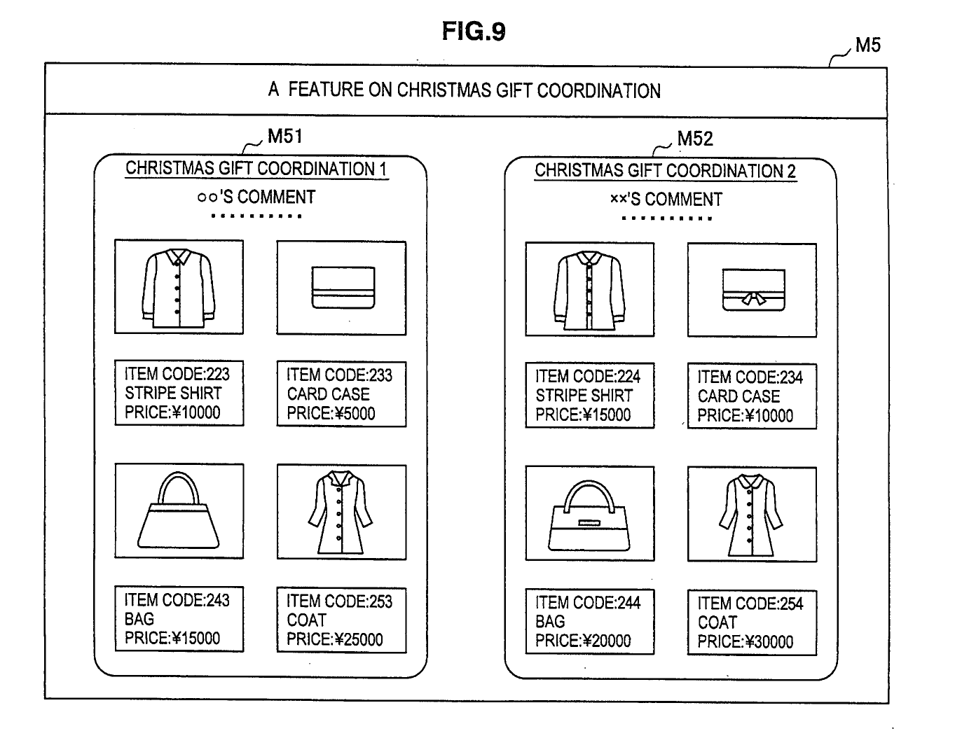

When a user determines the selection of the feature article, the EC server 30 displays an item list M4, M5 which includes the unit information for each feature article on the EC site, for example, as illustrated in FIG. 8 and FIG. 9. Here, the EC server 30 may previously obtain the unit information of each feature article from the advertisement server 40 or obtain the unit information of the selected feature article from the advertisement server 40 corresponding to the determination of selecting the feature article. Further, the EC server 30 obtains layout information for displaying the item information and the advertisement information which are included in the unit information from the advertisement server 40 along with the unit information for the feature article. Accordingly, the user can perform the purchase procedure by selecting the desired item while referring to the unit information for each feature article.

Here, the menu screen M3 may be posted on “•• EC site” which is provided by the EC server 30. The menu screen M3 may also be posted on a publication site or a blog site which is provided by another server or the advertisement site which is provided by the advertisement dealer 4. In the case that the menu screen M3 is posted on the site other than “•• EC site”, displaying of the item list is requested to the EC server 30 when the user determines the selection of the feature article. Then, the EC server 30 displays the item list which includes the unit information for each feature article on the EC site.

An example of the item list which includes the unit information for the feature article of “Recommended by ••! A Feature on This Fall's Dress” is illustrated in FIG. 8. The item list M4 displays four of the unit information Ua to Ud of the advertisement items A to D. Among the unit information of each advertisement item, the item list M4 indicates the information of the item name and the sale price included in the item information, and indicates the image of the advertisement model, the introduction article of the item, the information of the related items to be coordinated (i.e., a name and a sale price) and the like as the additional information.

For displaying the item list M4, the EC server 30 displays the item information and the advertisement information which are included in the unit information for the feature article in a predetermined layout as the item list M4. Thus, the user can perform the purchase procedure against the desired advertisement item by selecting the advertisement item displayed on the item list M4 so as to request execution of the purchase procedure.

FIG. 9 is an example of the item list which includes the unit information for the feature article of “A Feature on Christmas Gift Coordination”. The item list M5 indicates two combination examples M51, M52 of the advertisement items of a shirt, a card case, a bag and a coat which are introduced by each model in the advertisement article. Among the unit information of each advertisement item, the item list M5 indicates the introduction article included in the additional information and the information of the item code, the name, the image and the sale price included in the item information.

For displaying the item list M5 as well, the EC server 30 displays the item information and the advertisement information which are included in the unit information for the feature article in a predetermined layout as the item list M5. Thus, the user can perform the purchase procedure against the advertisement items which are included in the desired coordination at one time by selecting the coordination displayed on the item list M5 so as to request execution of the purchase procedure.

FIG. 10 is an example of the item list which includes the unit information for the sale feature of “Recommended by •• Site! A Feature on xx Brand Dress to be contained Fashion Girls October Issue” of “•• EC site”. The item list M6 indicates four of unit information of the advertisement item A of the knit dress, the advertisement item B of the velour dress, the advertisement item C of the jumper dress and the advertisement item F of the hound's tooth dress which are items of “•• brand”. Here, the advertisement item D of the line dress and the advertisement item E of the tweed dress are not included in the item list M6 since those are respectively the items of “xx brand” and “ΔΔ brand”. Among the unit information of each advertisement item, the item list M6 indicates the information of the item name and the sale price included in the item information, and indicates the image of the advertisement model, the introduction article of the item, the information of the related items and the like as the additional information.

For displaying the item list M6, the EC server 30 displays the item list M6 in an original layout by utilizing the unit information obtained from the advertisement server 40. The EC server 30 selects the unit information of the corresponding advertisement item based on the information of the manufacturing and selling source included in the item information of the unit information and the information of the name, the number of issue and the feature title of the publication contained in the additional information of the unit information. Then, the EC server 30 displays the item information and the advertisement information which are included in the selected unit information. Thus, the EC dealer 3 can sell the advertisement items while posting the unit information which is reedited in accordance with the own sale feature. On the other hand, the user can perform the purchase procedure against the desired advertisement item by selecting the advertisement item displayed on the item list M6 so as to request execution of the purchase procedure.

The EC dealer 3 becomes capable of selling the advertisement items with utilizing the information value of the advertisement information etc. which is prepared from the advertisement article data by posting the unit information of the advertisement item on the EC site. Accordingly, the EC dealer 3 can promote the sale of the advertisement items by enhancing purchase motivation of users compared with the sale method with the introduction information in related art. In particular, the EC dealer 3 becomes capable of selling with utilizing the information value of rapidness of the advertisement information etc. which is included in the unit information by posting the unit information of the advertisement items on the EC site earlier than the sale method in related art. Accordingly, the EC dealer 3 can promote the sale of the advertisement items by enhancing purchase motivation of users with utilizing the latest information of the advertisement items.

Further, in the case that a premium value of the advertisement item is enhanced in accordance with the rapidness of the advertisement information, it is also possible for the EC dealer 3 to expect a higher sale profit than that with the sale method in related art by further enhancing purchase motivation of users with utilizing a sale method of auction style. Further, it is also possible for the EC dealer 3 to perform commercial transaction such as purchasing, transportation and sale advantageously compared to competitors as a spillover effect.

When the user performs the purchase procedure of the advertisement item with utilizing the unit information (S24), the advertisement server 40 obtains the sales log of the advertisement item from the EC server 30 (S26). Here, the sales log may be provided to the advertisement server 40 from the EC server 30 in accordance with a request of the advertisement server 40 or may be automatically provided to the advertisement server 40 from the EC server 30. The sales log includes the information of the site browsing history of the purchaser along with the information such as the item code, the name, the date and time of the sale, the sale price, the purchaser and the sale site of the sale item. Based on the site browsing history which is included in the sales log, the advertisement dealer 4 can determine whether or not the advertisement item was sold with utilizing the unit information.

After the advertisement item is sold, the EC dealer 3 collects the sale charge from the user (S28). Then, the EC dealer 3 provides a predetermined sales margin which is included in the sale charge to the advertisement dealer 4 (S30). The advertisement dealer 4 obtains a predetermined intermediate margin which is included in the sales margin and provides (i.e., passes) the rest of the sales margin to the publisher 2 (S32). Thus, the publisher 2 can ensure a part of the sales margin of the advertisement item which is sold by utilizing the unit information as the non-advertisement profit (S34). Here, the publisher 2 may separately obtain the sales margin from the EC dealer 3 not though the advertisement dealer 4 and the advertisement dealer 4 may not obtain the intermediate margin.

The publisher 2 provides the advertisement article data to the advertisement dealer 4 so that the EC dealer 3 sells the advertisement items with utilizing the unit information which includes advertisement information prepared from the advertisement article data. Accordingly, the publisher 2 can ensure the non-advertisement profit by obtaining the sales margin corresponding to the sales log of the advertisement item from the EC system through which the advertisement item is sold with utilizing the unit information.

### (Modified Example of Posting Method of Unit Information)

In the following, a modified example of the posting method of the unit information will be described with reference to FIGS. 11 to 13. With the posting method of FIGS. 8 to 10, the unit information of a plurality of the advertisement items is displayed on the EC site as the item list M4 to M6 in which the unit information of the plurality of advertisement items is combined in the layout. Here, the unit information of the advertisement items may be displayed as the information which is related to one another.

The relating of the respective unit information is performed in accordance with each data included in the item information or the advertisement information. For example, a plurality of the unit information is related in accordance with the item category, the manufacturing and selling source, the advertisement model name, the introduction article, the name and the issue number of the publication, the feature title and the like. Specifically, the plurality of unit information is related in accordance with commonality and/or relativity of the item category, the manufacturing and selling source, the advertisement model name, keywords in the introduction article, the name and the issue number of the publication, and keywords in the feature title, for example.

A modified example of the configuration of the unit information of FIG. 6 is illustrated in FIG. 11. The additional information Ua to Ud of the unit information includes “••-chan” as the advertisement model name and “Recommended by ••! A Feature on This Fall's Dress” as the feature title of the advertisement article expected to be published. Therefore, the unit information Ua to Ud is related to one another in accordance with commonality of the advertisement model name and the feature title.

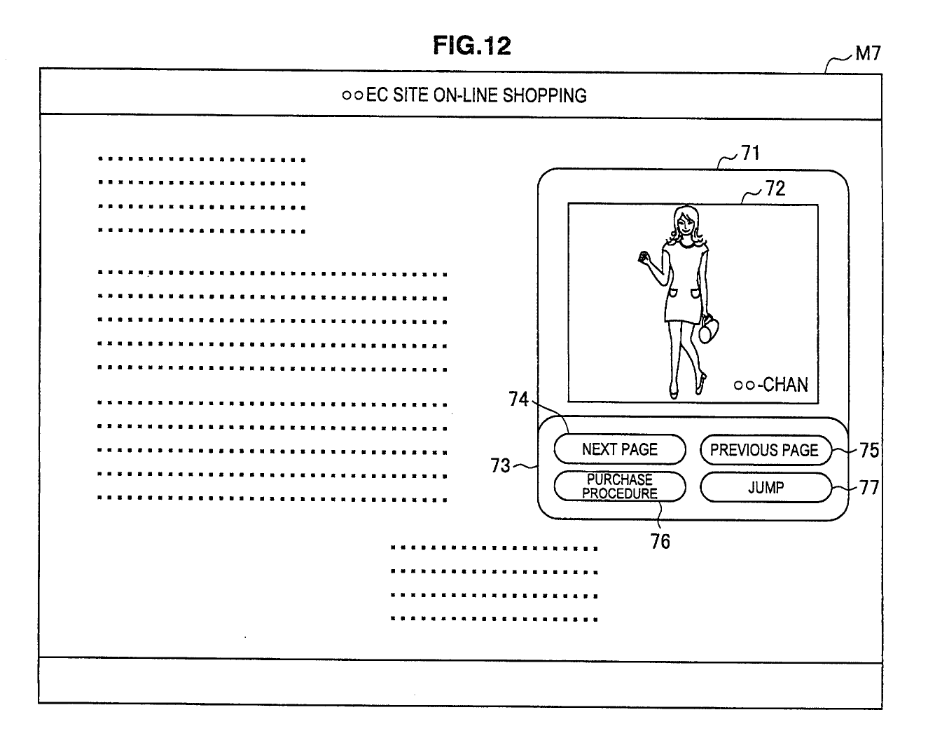

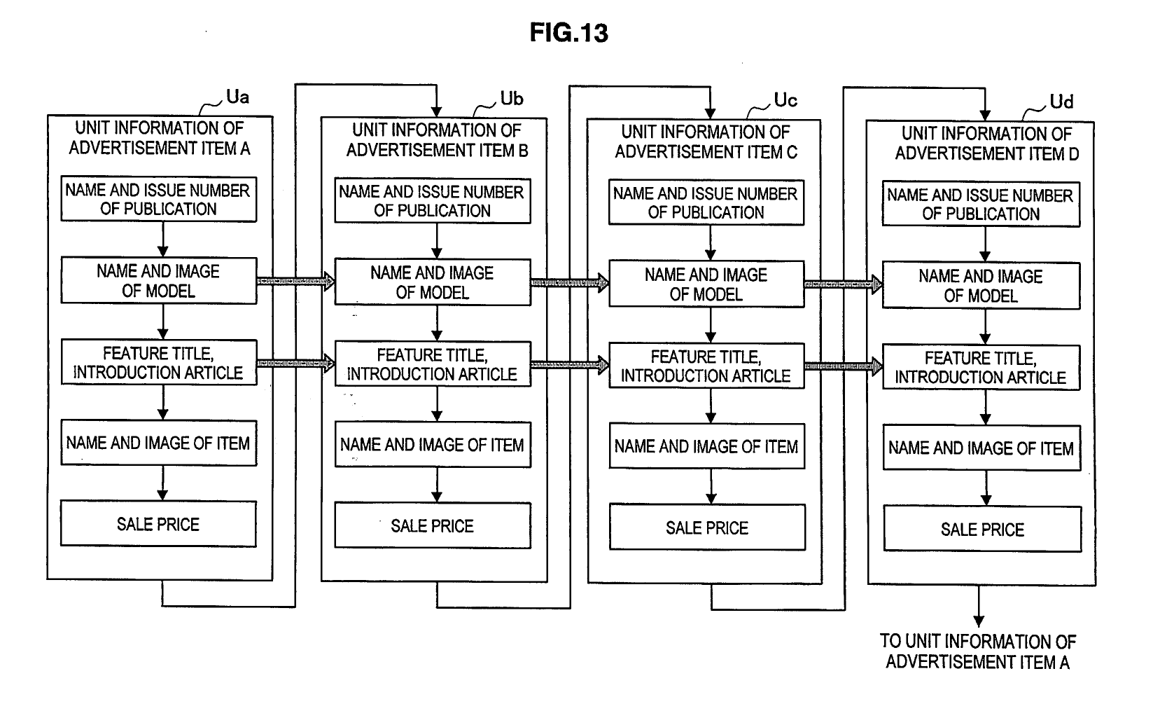

Modified examples of posting method of the unit information are illustrated in FIG. 12 and FIG. 13. With the posting method of FIG. 12, the data included in the unit information of the advertisement item is displayed at an item display portion 72 in the unit information display area 71 which is arranged on “•• EC site” provided by the EC server 30. Here, the unit information display area 71 may be arranged on the publication site, the blog site, the advertisement site or the like.

For example, predetermined data of the item information and the advertisement information included in the unit information are displayed at the item display portion 72 as page information in a predetermined order or at random. Further, a selection menu 73 for user's operation is arranged at the unit information display area 71. Operational buttons such as a button of “Next page” 74, a button of “Previous page” 75 and a button of “Purchase procedure” 76 are displayed in the selection menu 73, for example. In addition, a button of “Jump” 77 for display jumping among the unit information which is related to one another when a predetermined condition is satisfied is displayed in the selection menu 73.

An example of displaying order in the case that the data is displayed in the predetermined order is illustrated in FIG. 13. In the example of FIG. 13, the data included in the respective unit information is displayed in the order of unit information Ua, Ub, Uc and Ud. For displaying the respective unit information, the data included in the respective unit information is sequentially displayed at each page in the order of the name and the image of the publication in which the advertisement article is expected to be contained, the name and the image of the advertisement model, the feature title and the model's introduction article, the name and the image of the advertisement item, and the sale price. Here, the pages may be displayed by being automatically switched or by being switched in accordance with operation of the operational button such as the button of “Next page” 74 and the button of “Previous page” 75.

As described above, the unit information Ua to Ud are related to one another in accordance with the commonality of the advertisement model name. When the name and the image of the advertisement model included in the unit information Ua to Ud are displayed, the button of “Jump” 77 is displayed in the selection menu 73. Then, each time when the button of “Jump” 77 is operated by the user in the state that the unit information Ua is displayed, for example, the display of the item display portion 72 is switched to the name and the image of the advertisement model included in the unit information Ub, Uc and Ud.

When predetermined time elapses in the state that the button of “Jump” is displayed, the display of the item display portion 72 is switched to the feature title and the model's introduction article which are included in the unit information displayed at the item display portion 72. Then, similarly to the state before the button of “Jump” 77 is displayed, the data included in the respective unit information is displayed as being switched.

Here, in the case that the feature title and the model's introduction article which are included in the unit information Ua to Ud are displayed, the button of “Jump” 77 is similarly displayed as well. Then, each time when the button of “Jump” 77 is operated in the state that the unit information Ua is displayed, the display of the item display portion 72 is switched to the feature title and the model's introduction article which are included in the unit information Ub, Uc and Ud. When predetermined time elapses in the state that the button of “Jump” 77 is displayed, the display of the item display portion 72 is switched to the name and the image of the advertisement item.

When the button of “Purchase procedure” 76 is operated in the state that the unit information Ua is displayed, for example, a process of the purchase procedure is performed between the EC server 30 and the user. Here, in the case that the unit information display area 71 is arranged on the site other than “•• EC site”, the process of the purchase procedure is requested to a predetermined EC server 30 and the process of the purchase procedure is performed between this EC server 30 and the user.

With the abovementioned modified example of the posting method, since the unit information of the plurality of advertisement items is related in accordance with each data included in the item information or the advertisement information of the advertisement items, the user can browse the data having the relativity to one another included in the plurality of unit information with intuitive operation. Then, the user can easily select and purchase the desired advertisement item and the item related to the desired advertisement item. On the other hand, the publisher 2 (and the EC dealer 3) can enhance purchase motivation of the users and promote purchasing of the advertisement items by letting the users browse the items related to one another while encouraging the users to process purchasing with improved browsability of the item information and the advertisement information. Accordingly, the publisher 2 can efficiently ensure non-advertisement profits by the sale of advertisement items with utilizing the unit information related to one another.

### 3. Advertisement Providing System 110 According to the Second Embodiment

### 3-1. Configuration of Advertisement Providing System 110

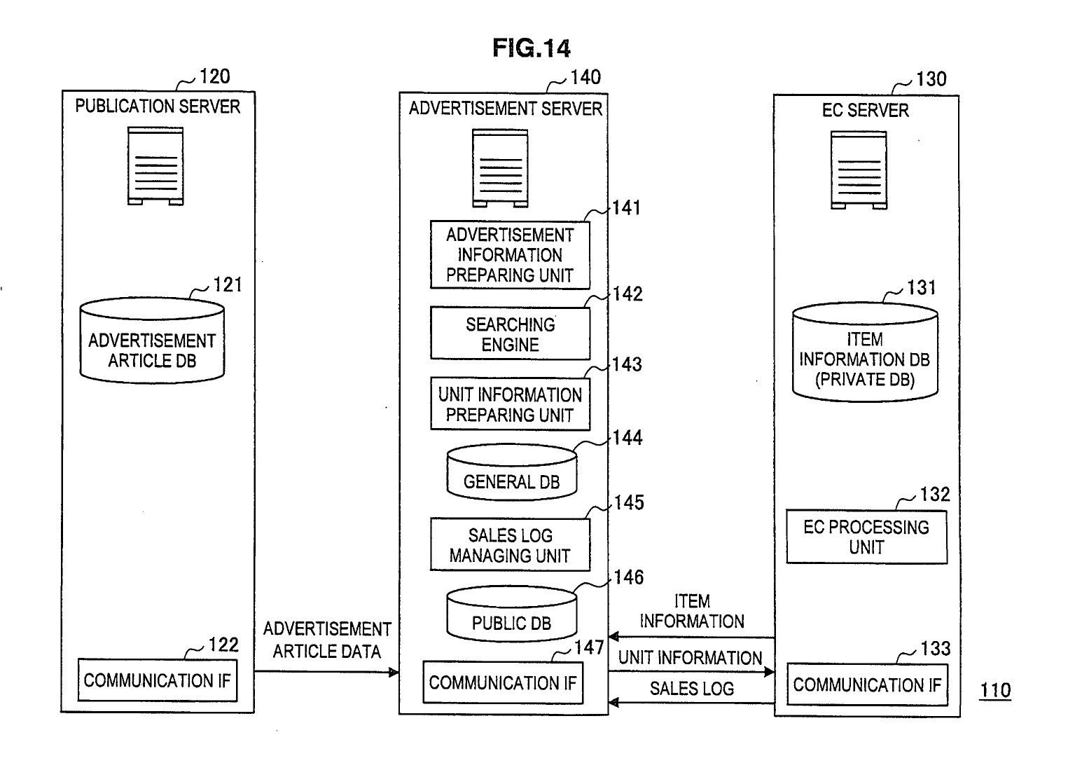

Next, the configuration of an advertisement providing system according to the second embodiment of the present invention will be described with reference to FIG. 14. As illustrated in FIG. 14, the advertisement providing system 110 according to the present embodiment includes a publication server 120, an EC server 130 and an advertisement server 140.

The publication server 120 includes an advertisement article database (DB) 121 which manages the advertisement article data expected to be contained in the publication and a communication interface (IF) 122 which performs data communication with the advertisement server 140. The EC server 130 includes an item information database (DB) 131 which manages the item information of items posted on the EC site, an EC processing unit 132 which performs electric commerce procedure through the EC site, and a communication interface (IF) 133 which performs data communication with the advertisement server 140. Here, the EC server 130 according to the present embodiment does not release the item information DB 131 to the advertisement dealer 4 and the like.

The advertisement server 140 includes an advertisement information preparing unit 141 which prepares the advertisement information from the advertisement article data, a searching engine 142 which searches the item information of the advertisement item, and a unit information preparing unit 143 which prepares the unit information of the advertisement item from the advertisement information and the item information. In addition, the advertisement server 140 includes a general database (DB) 144 which stores the advertisement information, the item information, the unit information and the like, a sales log managing unit 145 which manages the sales logs of the advertisement items, and a communication interface (IF) 147 which performs data communication with the publication server 120 and the EC server 130. Further, the advertisement server 140 according to the present embodiment has a public database (DB) 146 for releasing the unit information to the EC dealer 3 and the like. The EC dealer 3 can obtain the unit information by accessing the public DB 146.

### 3-2. Advertisement Providing Method

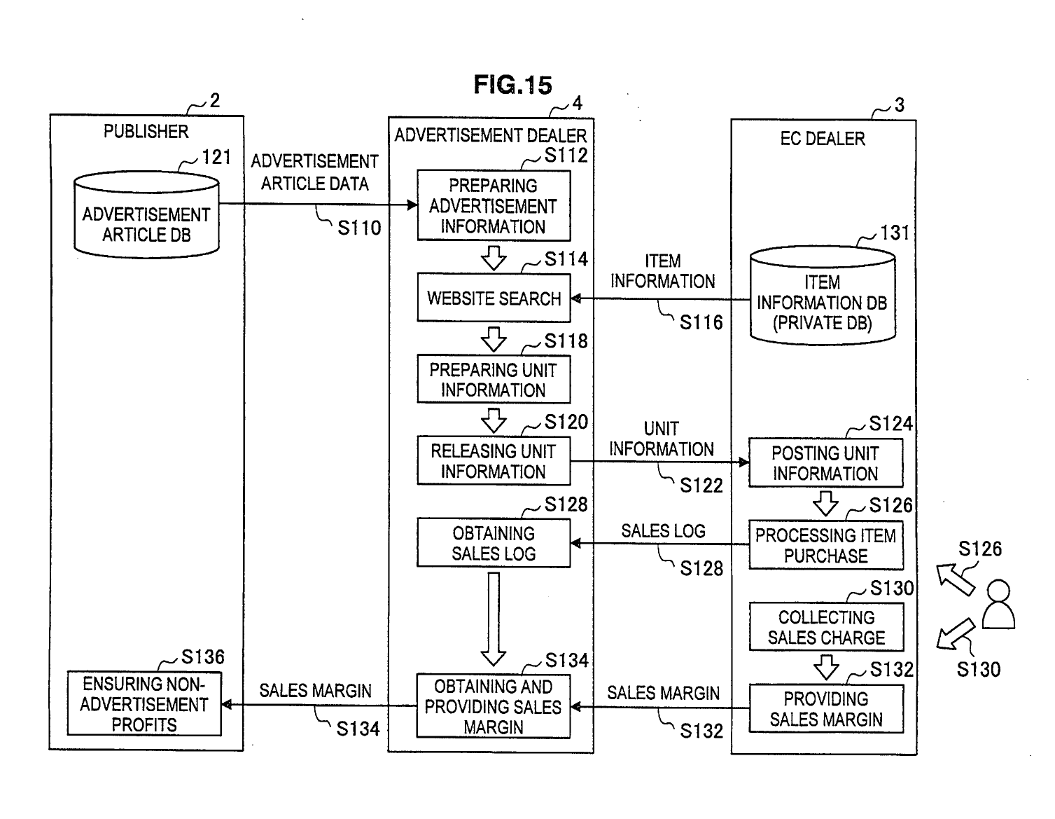

Next, the flow of an advertisement providing method according to the second embodiment of the present invention will be described with reference to FIG. 15.

The publisher 2 prepares the advertisement article of the advertisement item expected to be contained in the publication as DTP data and the like. The publication server 120 manages the advertisement article data with the advertisement article DB 121. The publication server 120 provides the advertisement article data to the advertisement server 140 (step S110).

After obtaining the advertisement article data from the publication server 120, the advertisement server 140 extracts the information of each advertisement item from the advertisement article and prepares the advertisement information of each advertisement item (S112). Then, the advertisement server 140 stores the advertisement information of each advertisement item at the general DB 144. After preparing the advertisement information of each advertisement item, the advertisement server 140 specifies the EC site which sells each advertisement item (S114). Here, as described above, since the item information DB 131 of each EC server 130 is not released, the advertisement server 140 specifies the EC site which sells each advertisement item by performing sequential retrieval using the item code and the name etc. in the advertisement information of each advertisement item as the search criteria.

After specifying the EC site which sells each advertisement item, the advertisement server 140 obtains the item information of each advertisement item from the EC site which sells each advertisement item (S116). Here, the item information is obtained from each EC site as the information including the item code, the name, the category, the image, the manufacturing and selling source, the sale price and the like of the item posted on each EC site. Then, the item information is stored at the general DB 144 of the advertisement server 140 after property information (i.e., a data code, an EC site code, data and time of preparation etc.) is added to respective item information.

After obtaining the item information of the advertisement item, the advertisement server 140 prepares the unit information by relating the advertisement information of each advertisement item prepared from the advertisement article data and the item information of each advertisement item obtained from each EC server 130 (S118).

After preparing the unit information, the advertisement server 140 releases the prepared unit information on the public DB 146 (S120). Each EC server 130 obtains the unit information of the advertisement item by accessing the public DB 146 (S122). Accordingly, the advertisement server 140 can provide the unit information to each EC server 130 by letting each EC server 130 obtain the unit information of the advertisement item through the public DB 146. After the unit information of the advertisement item is obtained, each EC server 130 posts the unit information of the advertisement item on each EC site and encourages the users to purchase the item with utilizing the unit information (S124).

When the user performs the purchase procedure of the advertisement item by utilizing the unit information (S126), the advertisement server 140 obtains the sales log of the advertisement item from the EC server 130 (S128). Here, the sales log includes the information of the site browsing history of the purchaser along with the information such as the item code, the date and time of the sale, the sale price, the sale site and the purchaser of the sale item. After the advertisement item is sold, the EC dealer 3 collects the sale charge from the user (S130). Then, the EC dealer 3 provides a predetermined sales margin which is included in the sale charge to the advertisement dealer 4 (S132). The advertisement dealer 4 obtains a predetermined intermediate margin which is included in the sales margin and provides (i.e., passes) the rest of the sales margin to the publisher 2 (S134). Thus, the publisher 2 can ensure a part of the sales margin of the advertisement item which is sold with utilizing the unit information as the non-advertisement profit (S136).

### 4. Summary

As described above, with the advertisement providing system 10, 110 according to the embodiment of the present invention, the advertisement information is prepared from the advertisement article data of the advertisement item expected to be contained in the publication and the item information is obtained from the EC server 30, 130 which sells the advertisement item. Then, the unit information of the advertisement item is prepared by relating the advertisement information and the item information of the advertisement item. Further, the unit information of the advertisement item is provided to the EC server 30, 130 which sells the advertisement item. The sales log of the advertisement item which is sold through the EC server 30, 130 with utilizing the unit information is obtained.

Thus, the publisher 2 can ensure the non-advertisement profit by obtaining the sales margin in accordance with the sales log of the advertisement item from the EC dealer 3 who sold the advertisement item with utilizing the unit information. Further, the publisher 2 can let the EC dealer 3 sell the advertisement item with utilizing the unit information which includes the advertisement article data of the advertisement item expected to be contained in the publication. In this manner, the publisher 2 can make use of the opportunity for ensuring non-advertisement profits with utilizing the information value of rapidness which the advertisement article data obtains between the preparation of the advertisement article data and the sale start of the publication.

It should be understood by those skilled in the art that various modifications, combinations, sub-combinations and alterations may occur depending on design requirements and other factors insofar as they are within the scope of the appended claims or the equivalents thereof.

In the above, the embodiments are described as the case of utilizing advertisement article data expected to be contained in a fashion magazine. However, the present invention is similarly applicable to the case of utilizing advertisement article data expected to be contained in other publications as well.

1. An advertisement providing system, comprising:
an advertisement article data obtaining unit which obtains advertisement article data of an advertisement item expected to be contained in a publication;
an advertisement information preparing unit which prepares advertisement information of the advertisement item from the obtained advertisement article data;
an item information obtaining unit which obtains item information of the advertisement item from an electric commerce system which sells the advertisement item;
a unit information preparing unit which prepares unit information of the advertisement item by relating the obtained advertisement information and the obtained item information;
a unit information providing unit which provides the prepared unit information to the electric commerce system which sells the advertisement item; and
a sales log obtaining unit which obtains a sales log of the advertisement item which is sold through the electric commerce system with utilizing the provided unit information.

2. The advertisement providing system according to claim 1,
wherein the unit information providing unit provides the prepared unit information to the electric commerce system which sells the advertisement item before sale start of the publication.

3. The advertisement providing system according to claim 1,
wherein the unit information preparing unit prepares the unit information of the advertisement item with data included in the advertisement information or the item information which constitute the unit information by being related to unit information of another advertisement item.

4. The advertisement providing system according to claim 1,
wherein the advertisement information preparing unit prepares the advertisement information of the advertisement item from the advertisement article data of the advertisement item and advertisement article data of an item other than the advertisement item.

5. The advertisement providing system according to claim 1,
wherein the item information obtaining unit obtains the item information of the advertisement item from a public database of the electric commerce system.

6. The advertisement providing system according to claim 1,
wherein the unit information providing unit provides the prepared unit information to the electric commerce system by releasing the prepared unit information on a public database of an advertisement system so that the electric commerce system which sells the advertisement item obtains the released unit information.

7. An advertisement providing method, comprising the steps of:
obtaining advertisement article data of an advertisement item expected to be contained in a publication;
preparing advertisement information of the advertisement item from the obtained advertisement article data;
obtaining item information of the advertisement item from an electric commerce system which sells the advertisement item;
preparing unit information of the advertisement item by relating the obtained advertisement information and the obtained item information;
providing the prepared unit information to the electric commerce system which sells the advertisement item; and
obtaining a sales log of the advertisement item which is sold through the electric commerce system with utilizing the provided unit information.

8. A program for causing a computer to execute an advertisement providing method which comprises steps of:
obtaining advertisement article data of an advertisement item expected to be contained in a publication;
preparing advertisement information of the advertisement item from the obtained advertisement article data;
obtaining item information of the advertisement item from an electric commerce system which sells the advertisement item;
preparing unit information of the advertisement item by relating the obtained advertisement information and the obtained item information;
providing the prepared unit information to the electric commerce system which sells the advertisement item; and
obtaining a sales log of the advertisement item which is sold through the electric commerce system with utilizing the provided unit information.
